(19) United States
(12) Patent Application Publication
(10) Pub. No.: US 2019/0138984 A1
(43) Pub. Date: May 9, 2019

(54) SYSTEMS AND METHODS FOR IDENTIFYING AND MANAGING DELAYED DELIVERIES

(71) Applicant: Walmart Apollo, LLC, Bentonville, AR (US)

(72) Inventors: Andrew B. Millhouse, Gilbert, AZ (US); Kresimir Jambresic, Centerton, AR (US); Chad Michael Smithpeters, Anchorage, AK (US)

(21) Appl. No.: 16/145,674

(22) Filed: Sep. 28, 2018

Related U.S. Application Data
(60) Provisional application No. 62/564,494, filed on Sep. 28, 2017.

(51) Int. Cl. G06Q 10/08; G06Q 30/02; G06Q 10/06

(52) U.S. Cl. CPC G06Q 10/0833; G06Q 10/087; G06Q 10/06315; G06Q 10/063116; G06Q 30/0202

(57) ABSTRACT

A sensor-based dynamic delivery system for a facility is provided. The system includes a computing system communicatively coupled to at least one location-based sensor associated with one or more carriers. The computing system is configured to execute a demand engine that when executed receives location data determined with respect to the location-based sensor. The demand engine identifies, using modeled delivery projections, at least one delayed delivery of one or more inventory items to the facility. The demand engine detects a potential inventory issue with respect to one or more items due to the at least one delayed delivery. The demand engine determines an expiration deadline until the facility runs out of the one or more inventory items based on the projected demand. The demand engine creates at least one of an order for, or a schedule for, a delivery with a servicing distribution center based on the determined expiration deadline.

### CROSS-REFERENCE TO RELATED PATENT APPLICATIONS

This application claims priority to U.S. Provisional Application No. 62/564,494, filed on Sep. 28, 2017, the content of which is hereby incorporated by reference in its entirety

### BACKGROUND

Within the modern economy, the transportation of items is increasingly critical to the success of an organization. In particular, large organizations may include multiple facilities in multiple geographic regions. A number of different transportation modalities may be utilized to transport items to facilities in these different regions via scheduled deliveries.

### BRIEF DESCRIPTION OF THE DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is an exemplary networked environment for a sensor-based dynamic delivery system for a facility, in accordance with embodiments of the present disclosure.

FIG. 2 is a flowchart process diagram for implementing a sensor-based dynamic delivery system for a facility, in accordance with embodiments of the present disclosure;

FIG. 3 is a flow chart of a demand engine determining a projected demand, in accordance with embodiments of the present disclosure;

FIG. 4 is an illustration of the demand engine determining a projected demand and scheduling a delivery based on the projected demand, in accordance with embodiments of the present disclosure; and

FIG. 5 is a block diagram of an exemplary computing device that can be used to perform one or more steps of the methods provided by exemplary embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Systems and methods are described herein for a sensor-based dynamic delivery system for a facility. A facility may be a store, factory, warehouse, freight transfer station, distribution center, or any other place that accepts deliveries. In an exemplary embodiment, the system includes at least one delivery vehicle, vessel, or train equipped with a location-based sensor. The location-based sensor may be a GPS sensor or may be detected via a geo-fence. The system further includes a scheduling database storing information regarding expected future deliveries of items from one or more carriers to the facility made via the delivery vehicle, vessel, or train, and information regarding estimated delivery durations based on at least one of a delivery method and a delivery type. The information regarding the expected future deliveries of items includes one or more of an expected delivery time, a departure time, a delivery method, a delivery type, a departure location, and a destination location of each carrier. The delivery method indicates how the items are being shipped (e.g., by boat, plane, truck, etc.). The delivery type is an identifier(s) of the items being shipped (e.g., groceries, furniture, electronics, etc.).

Continuing with the description of the exemplary embodiment, the system further includes a computing system communicatively coupled to the scheduling database and the location-based sensor(s). The computing system is configured to execute a demand engine that receives location data determined with respect to the location-based sensor. The demand engine models delivery projections for the carriers based on the location data, the information regarding expected future deliveries, and the information regarding estimated delivery durations. For example, the demand engine may project, based on the delivery method, the delivery type, the departure location, and the destination location, that the items will be delivered to the facility within a certain time period (e.g. within two weeks).

The demand engine in the exemplary embodiment uses the modeled delivery projections to identify at least one delayed delivery of one or more inventory items to the facility by at least one carrier. For example, the demand engine may determine that items projected to be delivered within two weeks had an expected delivery time of one week. The demand engine may detect a potential inventory issue with respect to one or more items due to the delayed delivery. The demand engine may further determine an expiration deadline until the facility runs out of the one or more inventory items. The demand engine may also determine a period without inventory of the one or more inventory items at the facility based on the expiration deadline and a date of a next expected future delivery of the one or more inventory items. The demand engine may further determine a projected demand of the one or more inventory items at the facility over the period without inventory.

To address the upcoming shortage, the demand engine may create at least one of an order for, or a schedule for, a delivery with a servicing distribution center based on the determined expiration deadline. In one embodiment, the demand engine is further configured to determine that one or more candidate facilities within a predefined proximity to the facility can provide the one or more inventory items, and generate a merchandise transfer request between the facility and the one or more candidate facilities.

In an embodiment, the scheduling database further stores an initial work schedule of personnel at the facility based on the information regarding expected future deliveries. The demand engine adjusts the initial work schedule based on the delayed delivery or deliveries to generate a new work schedule of personnel at the facility. The demand engine may transmit the new work schedule to one or more user devices associated with the personnel listed on the initial work schedule and the new work schedule (e.g. the work schedule may be transmitted to employee phones). The new work schedule may include at least one of altered employee schedules, added shifts, and offered new work shifts. In some embodiments, the offered new work shifts can be accepted via a mobile application on the one or more user devices.

In some embodiments, the demand engine, after identifying the at least one delayed delivery, programmatically triggers a rerouting of at least one carrier to the facility or schedule a new delivery to the facility from at least one carrier.

The dynamic delivery system described herein increases a speed and efficiency of determining delayed deliveries using a technical solution based on a location-based sensor and a scheduling database. The dynamic delivery system further resolves issues related to the delay using a technical solution of determining an expiration deadline until the facility runs out of the one or more inventory items and programmatically creating at least one of an order for, or a schedule for, a delivery with a servicing distribution center based on the determined expiration deadline.

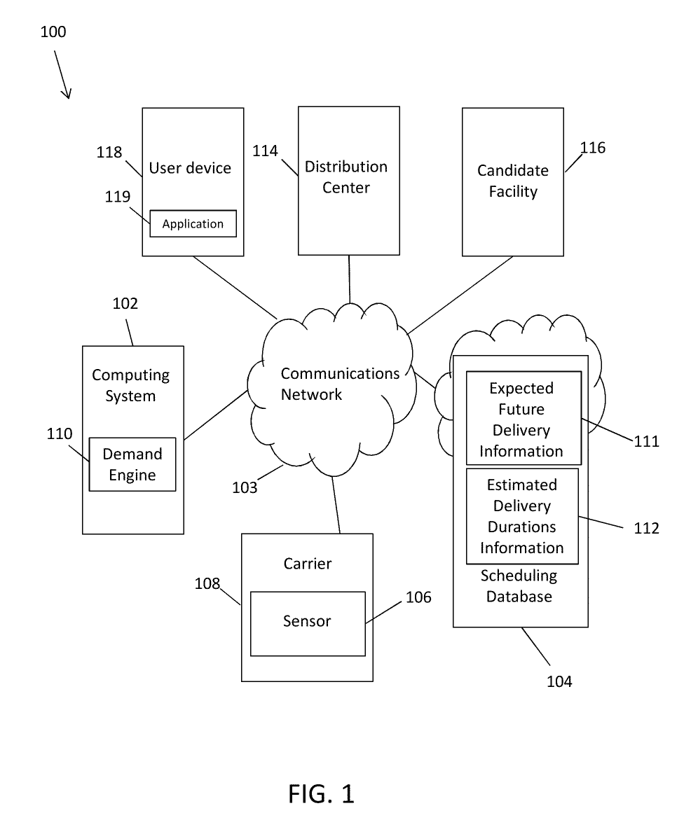

FIG. 1 is an exemplary networked environment 100 for a sensor-based dynamic delivery system for a facility, in accordance with embodiments of the present disclosure. The environment 100 includes a computing system 102 communicatively coupled, via communications network 103, to a scheduling database 104 and at least one location-based sensor 106 associated with a carrier vehicle 108, such as a delivery vehicle, a vessel, or a train. The computing system 102 is configured to execute a demand engine 110, as described herein. Although the scheduling database 104 is shown as remote from computing system 102, in alternative embodiments scheduling database 104 can exist within computing system 102. The scheduling database 104 stores expected future delivery information 111 regarding expected future deliveries of items from one or more carriers to a facility made via at least one delivery vehicle, vessel, or train, and estimated delivery duration information 112, which is based on at least one of a delivery method and a delivery type. The expected future delivery information 111 includes a delivery time. Exemplary delivery methods indicate how the items are being shipped (e.g., by a boat, a plane, a truck, etc.). Exemplary delivery types are identifiers of the items being shipped (e.g., groceries, furniture, electronics, etc.).

In some embodiments, the computing system 102 is communicatively coupled to at least one servicing distribution center 114 and/or at least one candidate facility 116 in order to create an order and/or schedule a delivery with at least one servicing distribution center 114 and/or at least one candidate facility 116. A distribution center is, for example, a warehouse or other specialized building that is stocked with items to be distributed to facilities. A candidate facility is a facility that can potentially supply another facility with items.

In some embodiments, the scheduling database 104 further stores an initial work schedule of personnel at the facility based on the expected future delivery information 111. As explained further herein demand engine 110 is further configured to adjust the initial work schedule based on a determination of at least one delayed delivery, and generate a new work schedule of personnel at the facility. The demand engine 110 transmits the new work schedule to one or more user devices 118 associated with the personnel listed on the initial work schedule and the new work schedule. As a non-limiting example, the new schedule may be transmitted to personal smartphones of facility personnel or alternatively may be transmitted to facility-distributed devices assigned to the personnel. The new work schedule may include at least one of altered employee schedules, added shifts, and offered new work shifts. In some embodiments, the offered new work shifts can be accepted via a mobile application 119 on the user device 118.

The communications network 103 can be any network over which information can be transmitted between devices communicatively coupled to the network. For example, the communication network 103 can be the Internet, an Intranet, virtual private network (VPN), wide area network (WAN), local area network (LAN), a cellular network and the like.

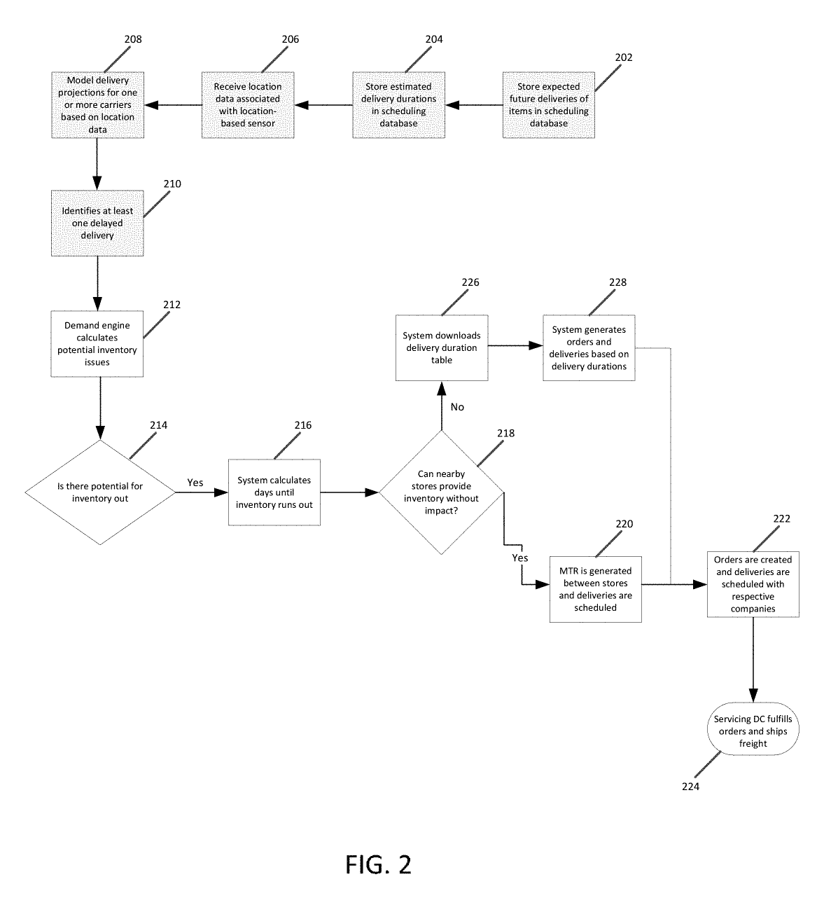

FIG. 2 is a flowchart process diagram for implementing a sensor-based dynamic delivery system for a facility, in accordance with embodiments of the present disclosure. At step 202, information regarding expected future deliveries of items from one or more carriers to a facility made via at least one delivery vehicle, vessel, or train, is stored in a scheduling database. Each expected future delivery of an item includes an expected delivery time. At step 204, information regarding estimated delivery durations based on at least one of a delivery method and a delivery type is stored in the scheduling database. At step 206, a demand engine, communicatively coupled to the scheduling database and at least one location-based sensor associated with the at least one delivery vehicle, vessel, or train, receives location data determined with respect to the location-based sensor. At step 208, the demand engine models delivery projections for the one or more carriers based on the location data, the information regarding expected future deliveries, and the information regarding estimated delivery durations.

At step 210, the demand engine identifies at least one delayed delivery of one or more inventory items to the facility by at least one carrier of one or more carriers (e.g., that a shipment of one or more inventory items to the facility is delayed). At step 212, the demand engine calculates potential inventory issues.

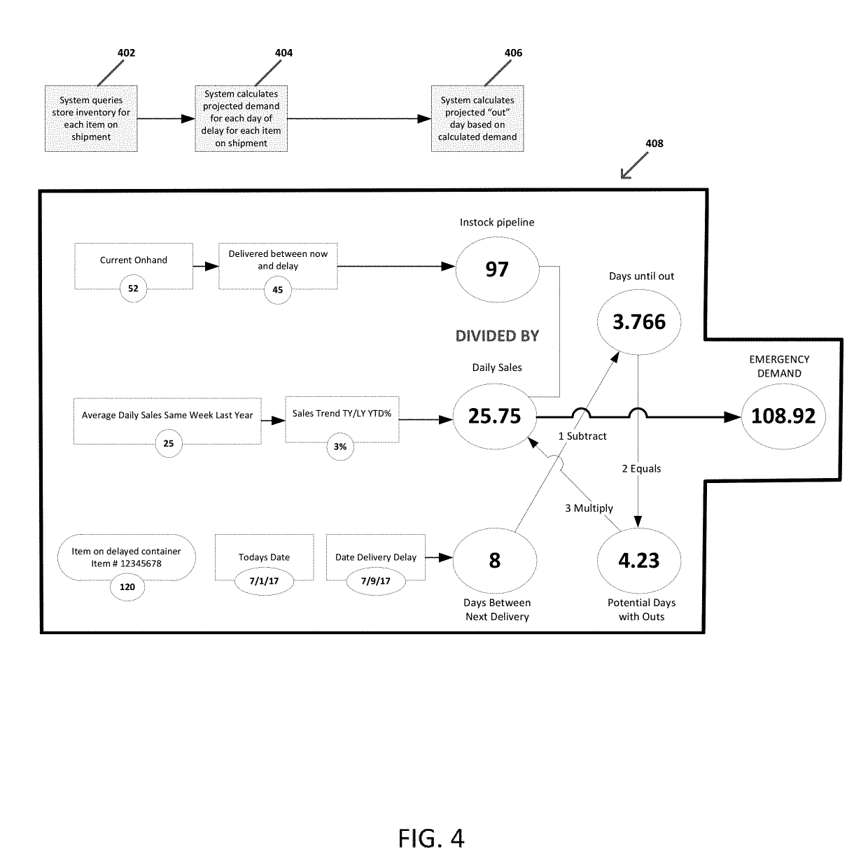

At step 214, the demand engine determines whether there is a potential for inventory out based on in-stock inventory and a projected sales rate based on historical demand, as described in FIG. 4. If yes, at step 216, the demand engine calculates a number of days until the inventory runs out based on the in-stock inventory and the projected sales rate and determines an inventory out date (also referred to as an expiration deadline). At step 218, the demand engine determines whether one or more candidate facilities within a predefined proximity to the facility can provide the one or more inventory items on or before the inventory out date without a negative impact to the candidate facility. If the one or more candidate facilities can provide the one or more inventory items, at step 220, the demand engine generates a merchandise transfer request (MTR) between the facility and the one or more candidate facilities. At step 222, the demand engine creates one or more orders and/or schedules one or more deliveries. At step 224, the servicing distribution center fulfills the one or more orders and ships the freight.

If the one or more candidate facilities cannot provide the one or more inventory items, at step 226, the demand engine downloads a delivery duration table. For example, the demand engine downloads the delivery duration table from an air and/or ground freight company. At step 228, the demand engine generates orders and deliveries based on delivery durations in the delivery duration table, with the delivery to occur on or before the inventory out date. At step 222, the demand engine creates one or more orders and/or schedules one or more deliveries. At step 224, the servicing distribution center fulfills the one or more orders and ships the freight.

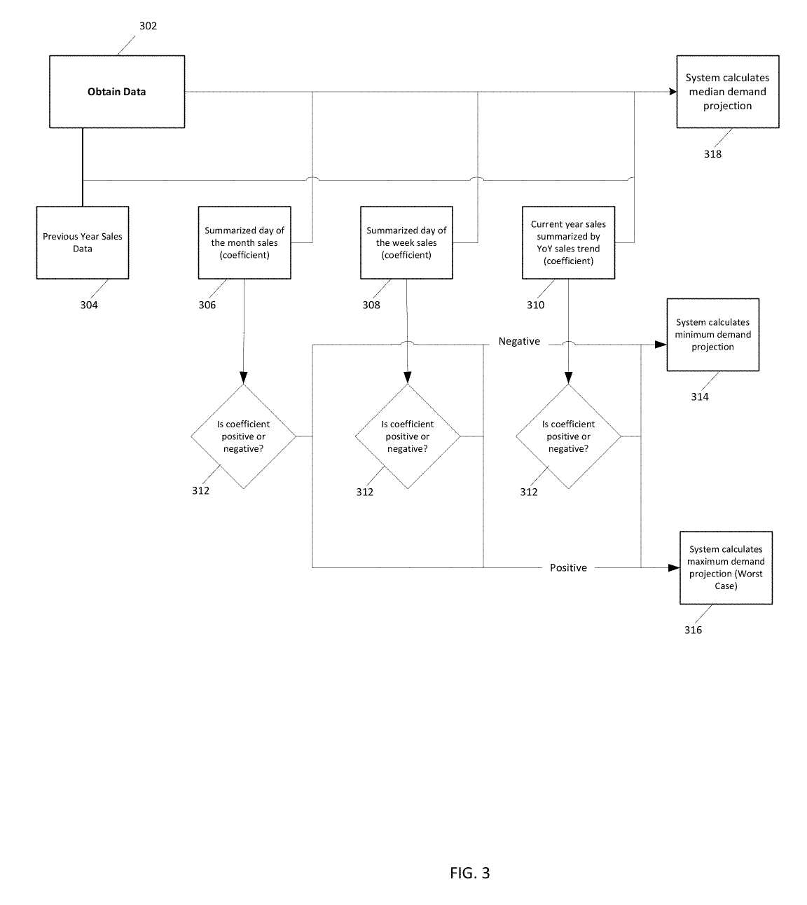

FIG. 3 is a flow chart of the demand engine determining a projected demand for an item, in accordance with embodiments of the present disclosure. The projected demand (also known as a demand projection) is a predicted future demand for an item within a facility over a predefined time period based on past sales. The projected demand is used to calculate items impacted by delay (e.g., a number of items projected to be sold over the time period potentially without inventory). At step 302, the demand engine obtains sales data for the item over one or more historical time periods, for example, previous years sales data 304, summarized day of the month sales 306, summarized day of the week sales 308, and/or current year sales summarized by year over year (YoY) sales trend 310.

The demand engine determines a sales change percentage (e.g., an increased or a decrease in sales) for an item based on the one or more historical time periods and one or more current time periods, resulting in a sales trend coefficient, as shown in FIG. 4. For example the demand engine may compare sales from Jan. 1, 2016-Jan. 7, 2016 and Jan. 1, 2017-Jan. 7, 2017 to determine whether there was a positive or negative change in sales. At step 312, the demand engine determines if the coefficient is positive (an increase in sales) or negative (a decrease in sales). If the coefficient is negative, at step 314, the demand engine calculates a minimum projected demand (e.g., a predicted minimum demand for the item at the facility). If the coefficient is positive, at step 316, the demand engine calculates a maximum projected demand (e.g., a predicted maximum demand for the item at the facility). If there is no change, at step 318, the demand engine calculates a median projected demand. An example of determining a projected demand is further described in FIG. 4.

Projected demand identifies a quantity of items needed to be transferred before the projected inventory out date. The items may be transferred from other stores within the market where demand is less than weeks on hand, or a request may be generated for an emergency shipment from the distribution network with faster shipment methods available.

FIG. 4 is an illustration of the demand engine determining a projected demand and scheduling a delivery based on the projected demand, in accordance with embodiments of the present disclosure. At step 402, following the determination of a delayed delivery, the demand engine queries a scheduling database storing information regarding expected future deliveries of items from one or more carriers to the facility. At step 404, the demand engine calculates a projected daily sales rate for each day of delay for each item scheduled for delivery, as described in FIG. 3. At step 406, the demand engine calculates a projected inventory out date based on the calculated projected daily sales rate.

As an example, in box 408, the demand engine queries an inventory database for the facility for each item scheduled for delivery. In the example, milk containers are scheduled for delivery. The demand engine determines that there are 52 milk containers in the inventory, with 45 additional milk containers being delivered before the estimated delayed delivery date (e.g. the delivery that is not arriving at the originally scheduled time), resulting in 97 milk containers estimated to be in-stock at the facility.

The demand engine retrieves data regarding average daily sales for the facility for a same week last year; for example, the facility sold 25 milk containers during the same week last year. The sales trend for this year vs. last year and year to date (TY/LY YTD) is a 3% increase in sales, resulting in projected daily sales of 25.75 milk containers.

The demand engine determines a projected out date based on the number of days until the facility is out of the item. The demand engine divides the 97 milk containers by the daily sales to determine there are 3.766 days until the facility runs out of inventory of milk containers (97 milk containers/daily sales of 25.75=3.766 days).

The demand engine calculates a projected demand for each item scheduled for delivery. For example, if current inventory is determined on July 1^{st} and the delivery date, originally scheduled for July 4^{th}, is now delayed to July 9^{th}, here are 8 days until the next delivery. Since inventory will be out in 3.766 days, the projected out date is approximately July 5^{th} Thus, there are 4.23 potential days without inventory (8 days−3.766 day=4.23 days). The demand engine multiplies the daily sales (25.75) by the potential days without inventory (4.23) to obtain a maximum projected demand of 108.92 milk containers.

The demand engine may then automatically order the needed demand and schedule it to arrive by the forecasted day out. For example, the demand engine may determine that 109 milk containers (25.75 daily sales*4.23 potential days without inventory) are needed until the next scheduled delivery. The demand engine may then schedule a delivery from a distribution center for 109 milk containers to arrive on or before July 5^{th} (the potential inventory out date). The 109 milk containers are projected to fulfill demand until the next delivery date of July 9^{th}.

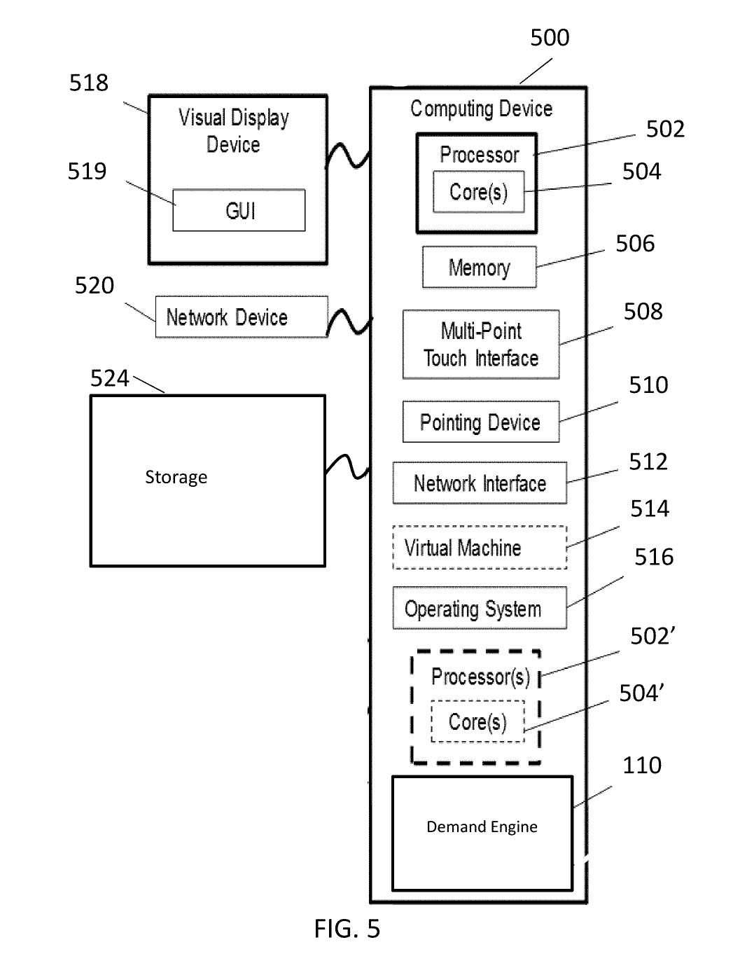

FIG. 5 is a block diagram of an exemplary computing device 500 that can be used to perform one or more steps of the methods provided by exemplary embodiments. In an exemplary embodiment, computing device 500 is computing system 102. Computing device 500 includes one or more non-transitory computer-readable media for storing one or more computer-executable instructions or software for implementing exemplary embodiments. The non-transitory computer-readable media can include, but are not limited to, one or more varieties of hardware memory, non-transitory tangible media (for example, one or more magnetic storage disks, one or more optical disks, one or more USB flashdrives), and the like. For example, a memory 506 included in computing device 500 can store computer-readable and computer-executable instructions or software for implementing exemplary embodiments. Computing device 500 also includes a processor 502 and an associated core 504, and optionally, one or more additional processor(s) 502′ and associated core(s) 504′ (for example, in the case of computer systems having multiple processors/cores), for executing computer-readable and computer-executable instructions or software stored in memory 506 and other programs for controlling system hardware. Processor 502 and processor(s) 502′ can each be a single core processor or multiple core (504 and 504′) processor. Computing device 500 may include at least one demand engine 110.

Virtualization can be employed in computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other varieties of memory as well, or combinations thereof. In some embodiments, a user can interact with computing device 500 through a visual display device 518, such as a touch screen display or computer monitor, which can display one or more user interfaces 519 that can be provided in accordance with exemplary embodiments, for example, the exemplary user interfaces. Visual display device 518 may also display other aspects, elements and/or information or data associated with exemplary embodiments. For example, the visual display device 518 may display schedules, orders, information regarding expected future deliveries, information regarding estimated delivery durations, expiration deadlines, work schedules of personnel at the facility, and new delivery projections for the one or more carriers. Computing device 500 may include other I/O devices for receiving input from a user, for example, a keyboard or any suitable multi-point touch interface 508, a pointing device 510 (e.g., a pen, stylus, mouse, or trackpad). The keyboard 508 and pointing device 510 may be coupled to visual display device 518. Computing device 500 may include other suitable conventional I/O peripherals.

Computing device 500 can also include one or more storage devices 524, such as a hard-drive, CD-ROM, or other computer readable media, for storing data and computer-readable instructions and/or software, that implements embodiments of the specialized computer file system, as described herein, or portions thereof. Exemplary storage device 524 can also store one or more storage devices for storing any suitable information required to implement exemplary embodiments. Storage device 524 includes one or more databases, such as scheduling database 104.

Computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or any other device suitable for interfacing computing device 500 to any variety of networks capable of communication and performing the operations described herein. Moreover, computing device 500 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 500 can run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 516 can be run in native mode or emulated mode. In an exemplary embodiment, the operating system 516 can be run on one or more cloud machine instances.

The following description is presented to enable any person skilled in the art to create and use a computer system configuration and related method and systems for improving access to electronic data. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A sensor-based dynamic delivery system for a facility, the system comprising:
at least one delivery vehicle, vessel, or train equipped with a location-based sensor;
a scheduling database storing:
information regarding expected future deliveries of items from one or more carriers to the facility made via the at least one delivery vehicle, vessel, or train, wherein the information regarding each expected future delivery includes an expected delivery time; and
information regarding estimated delivery durations based on at least one of a delivery method and a delivery type;
a computing system communicatively coupled to the scheduling database and the at least one location-based sensor, the computing system configured to execute a demand engine that when executed:
receives location data determined with respect to the location-based sensor;
models delivery projections for the one or more carriers based on the location data, the information regarding expected future deliveries, and the information regarding estimated delivery durations;
identifies, using the modeled delivery projections, at least one delayed delivery of one or more inventory items to the facility by at least one carrier of the one or more carriers;
detects a potential inventory issue with respect to one or more items due to the at least one delayed delivery;
determines an expiration deadline until the facility runs out of the one or more inventory items;
determines a period without inventory of the one or more inventory items at the facility based on the expiration deadline and a date of a next expected future delivery of the one or more inventory items;
determines a projected demand of the one or more inventory items at the facility during the period without inventory; and
creates at least one of an order for, or a schedule for, a delivery with a servicing distribution center based on the determined expiration deadline and the projected demand.

2. The system of claim 1, wherein the demand engine when executed determines the expiration deadline by:
calculating a projected sales rate of the one or more inventory items based on historical information and sales trends;
determining a quantity of the one or more inventory items in stock at the facility; and
calculating a projected inventory out date based on the projected sales rate and the inventory quantity, the projected inventory out date being a day the facility is expected to run out of the one or more inventory items.

3. The system of claim 1, wherein the demand engine when executed:
determines that one or more candidate facilities within a predefined proximity to the facility can provide the one or more inventory items; and
generates a merchandise transfer request between the facility and the one or more candidate facilities.

4. The system of claim 1, wherein the demand engine when executed further:
determines that one or more candidate facilities within a predefined proximity to the facility cannot provide the one or more inventory items prior to the determined expiration deadline;
downloads the information regarding estimated delivery durations; and
creates at least one of an order for, or schedule for, the delivery with a servicing distribution center based on the estimated delivery durations.

5. The system of claim 1, the projected demand includes a median projected demand or a maximum projected demand.

6. The system of claim 1, wherein the location-based sensor is a GPS sensor or is a sensor detected via a geo-fence.

7. The system of claim 1, wherein the identifying of the at least one delayed delivery programmatically triggers at least one of rerouting at least one carrier of the one or more carriers to the at least one facility or scheduling a new delivery to the at least one facility from at least one carrier of the one or more carriers.

8. The system of claim 1, wherein the scheduling database further stores an initial work schedule of personnel at the facility based on the information regarding expected future deliveries, and the demand engine when executed further:
adjusts the initial work schedule based on the at least one delayed delivery to
generate a new work schedule of personnel at the facility; and
transmits the new work schedule to one or more user devices associated with the personnel listed on the initial work schedule and the new work schedule.

9. The system of claim 8, wherein the new work schedule includes at least one of altered employee schedules, added shifts, and offered new work shifts.

10. The system of claim 8, wherein the offered new work shifts can be accepted via a mobile application on the one or more user devices.

11. A computer-implemented method for performing sensor-based dynamic deliveries for a facility, the method comprising:
storing information, in a scheduling database, regarding expected future deliveries of items from one or more carriers to the facility made via at least one delivery vehicle, vessel, or train, wherein each expected future delivery includes an expected delivery time;
storing information, in the scheduling database, regarding estimated delivery durations based on at least one of a delivery method and a delivery type;
receiving, by a computing system communicatively coupled to the scheduling database and at least one location-based sensor associated with the at least one delivery vehicle, vessel, or train, location data determined with respect to the location-based sensor;
modeling, by the computing system, delivery projections for the one or more carriers based on the location data, the information regarding expected future deliveries, and the information regarding estimated delivery durations;
identifying, by the computing system, using the modeled delivery projections, at least one delayed delivery of one or more inventory items to the facility by at least one carrier of the one or more carriers;
detecting, by the computing system, a potential inventory issue due to the at least one delayed delivery;
determining, by the computing system, an expiration deadline until the facility runs out of the one or more inventory items;
determining, by the computing system, a period without inventory of the one or more inventory items at the facility based on the expiration deadline and a date of a next expected future delivery of the one or more inventory items;
determining, by the computing system, a projected demand of the one or more inventory items during the period without inventory; and
at least one of creating an order or scheduling a delivery, by the computing system, with a servicing distribution center based on the expiration deadline until the facility runs out of the one or more inventory items and the projected demand.

12. The method of claim 11, further comprising:
determining, by the computing system, the deadline until the facility runs out of the one or more inventory items by:
calculating a projected sales rate of the one or more inventory items based on historical information and sales trends;
determining a quantity of the one or more inventory items in stock at the facility; and
calculating a projected inventory out date based on the projected sales rate and the inventory quality, the projected out date being a day the facility is expected to run out of the one or more inventory items.

13. The method of claim 11, further comprising:
determining, by the computing system, that one or more candidate facilities within a predefined proximity to the facility can provide the one or more inventory items; and
generating, by the computing system, a merchandise transfer request between the facility and the one or more candidate facilities.

14. The method of claim 11, further comprising:
determining, by the computing system, that one or more candidate facilities within a predefined proximity to the facility cannot provide the one or more inventory items;
downloading, by the computing system, the estimated delivery durations; and
at least one of creating the order or scheduling the delivery, by the computing system, with a servicing distribution center based on the delayed delivery based on the estimated delivery durations.

15. The method of claim 11, the projected demand includes a median projected demand or a maximum projected demand.

16. The method of claim 11, wherein the location-based sensor is a GPS sensor or is detected via a geo-fence.

17. The method of claim 11, wherein the identifying of the at least one delayed delivery programmatically triggers at least one of rerouting at least one carrier of the one or more carriers to the at least one facility or scheduling a new delivery to the at least one facility from at least one carrier of the one or more carriers.

18. The method of claim 11, further comprising:
storing, in the scheduling database, an initial work schedule of personnel at the facility based on the information regarding expected future deliveries;
adjusting, by the computing system, the initial work schedule based on the at least one delayed delivery to generate a new work schedule of personnel at the facility; and
transmitting, by the computing system, the new work schedule to one or more user devices associated with the personnel listed on the initial work schedule and the new work schedule.

19. The method of claim 18, wherein the new work schedule includes at least one of altered employee schedules, added shifts, and offered new work shifts.

20. The method of claim 18, wherein the offered new work shifts can be accepted via a mobile application on the one or more user devices.
